(19) United States
(12) Patent Application Publication
(10) Pub. No.: US 2025/0147311 A1
(43) Pub. Date: May 8, 2025

(54) LATERAL COLOR ALIGNMENT CORRECTION FOR DIFFRACTIVE WAVEGUIDES

(71) Applicant: GOOGLE LLC, Mountain View, CA (US)

(72) Inventor: Thomas Hoekman, Redwood City, CA (US)

(21) Appl. No.: 18/502,760

(22) Filed: Nov. 6, 2023

(51) Int. Cl. G02B 27/01; G02B 6/34

(52) U.S. Cl. CPC G02B 27/0172; G02B 6/34; G02B 27/0179; G02B 2027/011; G02B 2027/0123; G02B 2027/0178; G02B 2027/0187

(57) ABSTRACT

One or more diffractive gratings of a waveguide introduce a phase perturbation to offset a lateral color misalignment due to surface deformations such as non-parallelism of the major surfaces of the waveguide. In some embodiments, a pitch and/or angle of the diffractive grating is tuned to change the k-vector of the grating in the direction of a change in total thickness variation (TTV) across the waveguide.

### BACKGROUND

The present disclosure relates generally to augmented reality (AR) eyewear, which fuses a view of the real world with a heads-up display overlay. Wearable display devices, which include wearable heads-up displays (WHUDs) and head-mounted display (HMD) devices (all of which may be used interchangeably herein), are wearable electronic devices that combine real world and virtual images via one or more optical combiners, such as one or more integrated combiner lenses, to provide a virtual display that is viewable by a user when the wearable display device is worn on the head of the user. One class of optical combiner uses a waveguide (also termed a lightguide) to transfer light. In general, light from a projector of the wearable display device enters the waveguide of the optical combiner through an incoupler, propagates along the waveguide, and exits the waveguide through an outcoupler. If the pupil of the eye is aligned with one or more exit pupils provided by the outcoupler, at least a portion of the light exiting through the outcoupler will enter the pupil of the eye, thereby enabling the user to see a virtual image. Since the combiner lens is transparent, the user will also be able to see the real world.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a rear perspective view of an augmented reality display device implementing waveguide with a diffractive grating having a phase perturbation to offset a lateral separation of colors of display light caused by surface deformations in the waveguide in accordance with some embodiments.

FIG. 2A is a diagram illustrating total thickness variation (TTV) across components of a waveguide and FIG. 2B is a corresponding x-space diagram illustrating ray paths for different colors of display light to an exit pupil in accordance with some embodiments.

FIG. 3 is a diagram illustrating paths of display light within components of a waveguide having surface deformations resulting in TTV across the components.

FIG. 4 is a diagram illustrating paths of display light within a side view of a waveguide having surface deformations resulting in TTV across the components.

FIGS. 5A and 5B are a pair of spot diagrams illustrating lateral color misalignment due to surface deformations across components of a waveguide.

FIG. 6 is a side view of a grating structure having a phase perturbation to offset a lateral color misalignment due to surface deformations of a waveguide in accordance with some embodiments.

FIGS. 7A and 7B are a pair of spot diagrams illustrating correction by a phase perturbation of a grating structure of lateral color misalignment due to surface deformations of a waveguide in accordance with some embodiments.

FIG. 8 is a flow diagram illustrating a method of adding a phase perturbation to a grating structure to offset lateral color misalignment due to surface deformations of a waveguide in accordance with some embodiments.

### DETAILED DESCRIPTION

A diffractive waveguide typically includes an incoupler (IC), an exit pupil expander (EPE), and an outcoupler (OC). In some cases, the waveguide includes an IC and a two-dimensional combined EPE/OC. The optical beam cross section at a light source (i.e., display engine) of an AR eyewear display device is typically smaller than the cross section of display light that is guided to an eyebox for viewing by a user at the user's pupil position. The EPE expands the optical beam cross section by diffracting a portion of the display light each time the light hits a grating structure of the EPE, thus replicating the exit pupil multiple times to achieve a larger eyebox. The EPE allows the remainder of the display light to pass through or go through total internal reflection (TIR).

Typically, the process of manufacturing a waveguide results in surface deformations that cause the thickness of the waveguide to vary from one point to another. For example, in some cases multiple waveguides are singulated from a wafer that has a variable thickness from the center to the periphery. For example, the wafer may have a dome shape that is thicker at the center and slightly thinner at the edge. The components of multiple waveguides are typically laid out radially on the wafer, with the input coupler for each waveguide located near the center of the wafer and the EPE and outcoupler for each waveguide located nearer to the outer edge of the wafer. A diagonal (e.g., 45 degree) cross section of each resulting waveguide has a wedge profile that is thicker at the incoupler and thinner at the outcoupler in some embodiments.

As collimated light from a micro-display or other light engine is guided through the waveguide via TIR, the variable thickness of the waveguide affects display light of different wavelengths differently. Because the major surfaces of the waveguide are not parallel, each reflection of light off a major surface of the waveguide deflects the light slightly. The amount by which each ray of light is deflected depends on the field angle and wavelength of the light. For example, blue light, which has a shorter wavelength, undergoes more reflective interactions (bounces) within the waveguide and is therefore deflected to a greater extent than light having a longer wavelength (e.g., red light), which undergoes fewer bounces within the waveguide. The disparate effects on different wavelengths of light as it travels through the waveguide results in lateral color misalignment, in which different colors of light are dispersed, thus degrading image quality at an eyebox of the waveguide. The magnitude of the image quality degradation is proportional to the magnitude of the surface deformation (e.g., total thickness variation of the waveguide).

Although strict specifications are typically placed to limit waveguide deformation within manufacturing tolerances, in some instances a degree of surface deformation can improve waveguide efficiency. For example, rays of display light may for interference loops in the EPE or other pupil expanding grating elements of a waveguide that can result in destructive interference that reduces waveguide efficiency. If the surface profile of the waveguide is engineered such that the major surfaces of the waveguide are not perfectly parallel, ray paths along an interference loop will be substantially different, such that coherence no longer exists where the rays intersect. However, whether non-parallelism or other surface deformations of a waveguide are introduced unintentionally (e.g., as a consequence of the manufacturing process) or intentionally (e.g., to destroy coherent artifacts), the resulting lateral color misalignment degrades image quality.

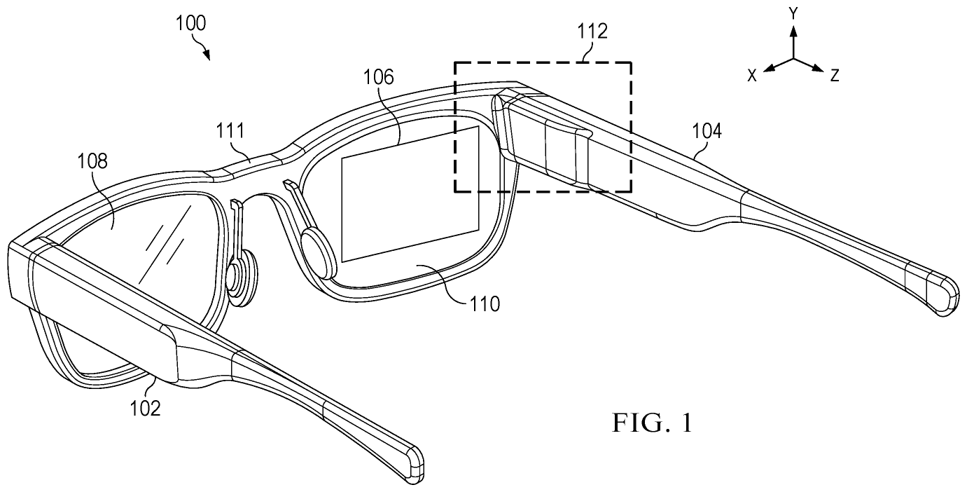

FIGS. 1 and 5-7 illustrate techniques for introducing a phase perturbation to one or more diffractive gratings of a waveguide to counter the lateral color misalignment due to surface deformations such as non-parallelism of the major surfaces of the waveguide. In some embodiments, a pitch and/or angle of the diffractive grating is tuned to change the k-vector of the grating in the direction of change in total thickness variation (TTV) across the waveguide. Because diffractive gratings are intrinsically dispersive, adding a small change in the k-vector of the grating in the direction of the TTV has a greater effect on red light than on blue light, thereby improving the lateral color alignment of light guided through the waveguide.

The more interactions a ray has with the waveguide surface, the more deflection the ray will experience. Thus, the further a ray travels within the waveguide, the further the ray will be deflected and the more the colors will separate laterally. To counter this effect, in some embodiments, the degree by which the k-vector of the diffractive grating is modified varies with the propagation distance of the light rays within the waveguide. For example, in some embodiments the degree of phase perturbation introduced to the diffractive grating varies spatially across the grating to reduce the accumulated color dispersion at each position of the grating.

Because not all rays across the field of view (FOV) of an eyewear display device incorporating the waveguide are deflected by an equal angle by the phase perturbation (although they are deflected by a substantially equal k-space vector), some deformation may be introduced into the image. In some cases, the deformation changes based on the location of the user's pupil within the eyebox of the waveguide. To compensate for the variable image deformation based on pupil position within the eyebox, in some embodiments, the eyewear display device includes an eye tracker and a controller to apply an image distortion compensation effect to the projected display light based on a detected pupil location.

FIG. 1 is a diagram illustrating a rear perspective view of an augmented reality display device implementing waveguide with a diffractive grating having a phase perturbation to offset a lateral separation of colors of display light caused by surface deformations in the waveguide in accordance with some embodiments. The AR eyewear display system 100 includes a support structure 102 (e.g., a support frame) to mount to a head of a user and that includes an arm 104 that houses a laser projection system, micro-display (e.g., micro-light emitting diode (LED) display), or other light engine configured to project display light representative of images toward the eye of a user, such that the user perceives the projected display light as a sequence of images displayed in a field of view (FOV) area 106 at one or both of lens elements 108, 110 supported by the support structure 102. In some embodiments, the support structure 102 further includes various sensors, such as one or more front-facing cameras, rear-facing cameras (e.g., for eye tracking), other light sensors, motion sensors, accelerometers, and the like. The support structure 102 further can include one or more radio frequency (RF) interfaces or other wireless interfaces, such as a Bluetooth™ interface, a WiFi interface, and the like.

The support structure 102 further can include one or more batteries or other portable power sources for supplying power to the electrical components of the AR eyewear display system 100. In some embodiments, some or all of these components of the AR eyewear display system 100 are fully or partially contained within an inner volume of support structure 102, such as within the arm 104 in region 112 of the support structure 102. In the illustrated implementation, the AR eyewear display system 100 utilizes an eyeglasses form factor. However, the AR eyewear display system 100 is not limited to this form factor and thus may have a different shape and appearance from the eyeglasses frame depicted in FIG. 1.

One or both of the lens elements 108, 110 are used by the AR eyewear display system 100 to provide an AR display in which rendered graphical content can be superimposed over or otherwise provided in conjunction with a real-world view as perceived by the user through the lens elements 108, 110. For example, laser light or other display light is used to form a perceptible image or series of images that are projected onto the eye of the user via one or more optical elements, including a waveguide, formed at least partially in the corresponding lens element. One or both of the lens elements 108, 110 thus includes at least a portion of a waveguide that routes display light received by an incoupler (IC) (not shown in FIG. 1) of the waveguide to an outcoupler (OC) (not shown in FIG. 1) of the waveguide, which outputs the display light toward an eye of a user of the AR eyewear display system 100. Additionally, the waveguide employs an exit pupil expander (EPE) (not shown in FIG. 1) in the light path between the IC and OC, or in combination with the OC, in order to increase the dimensions of the display exit pupil. Each of the lens elements 108, 110 is sufficiently transparent to allow a user to see through the lens elements to provide a field of view of the user's real-world environment such that the image appears superimposed over at least a portion of the real-world environment.

In some embodiments, one or more of the IC, OC, and/or EPE use diffractive waveguide facets either to diffract light from one surface of the waveguide back to the same surface or to allow light to travel through the facets from one surface of the waveguide to a different, opposing surface of the waveguide. In some embodiments, the major surfaces of the waveguide are not parallel or have other deformations that deflect light rays traveling through the waveguide from their nominal orientation within the waveguide. The degree to which rays are deflected by the surface deformations depends on the magnitude of the deformation, the length of the ray's path through the lightguide, and the input angle of the ray. Because light having a shorter wavelength experiences more bounces and therefore travels a longer path within the waveguide than light having a longer wavelength, the different colors of light become laterally separated in the final output image. In order to compensate for the lateral color misalignment due to surface deformations of the waveguide, the grating structure of the EPE and/or the OC include a phase perturbation to offset the deflection caused by the total thickness variation of the waveguide. For example, in some embodiments, the pitch and/or grating direction of the grating structure of the EPE and/or the OC is tuned to offset the lateral color misalignment introduced by the surface deformations of the waveguide.

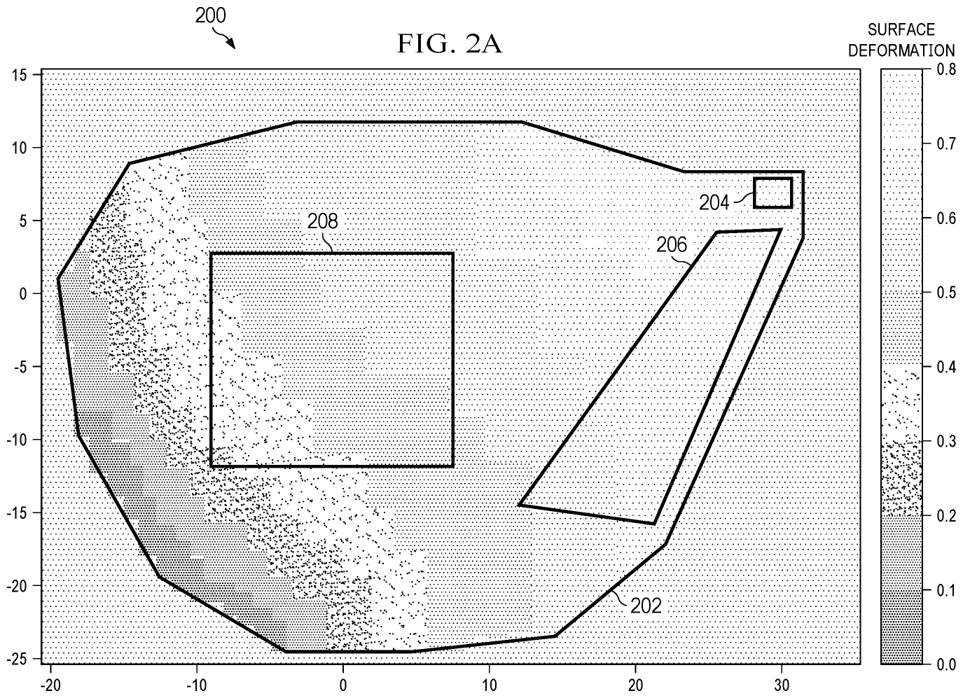

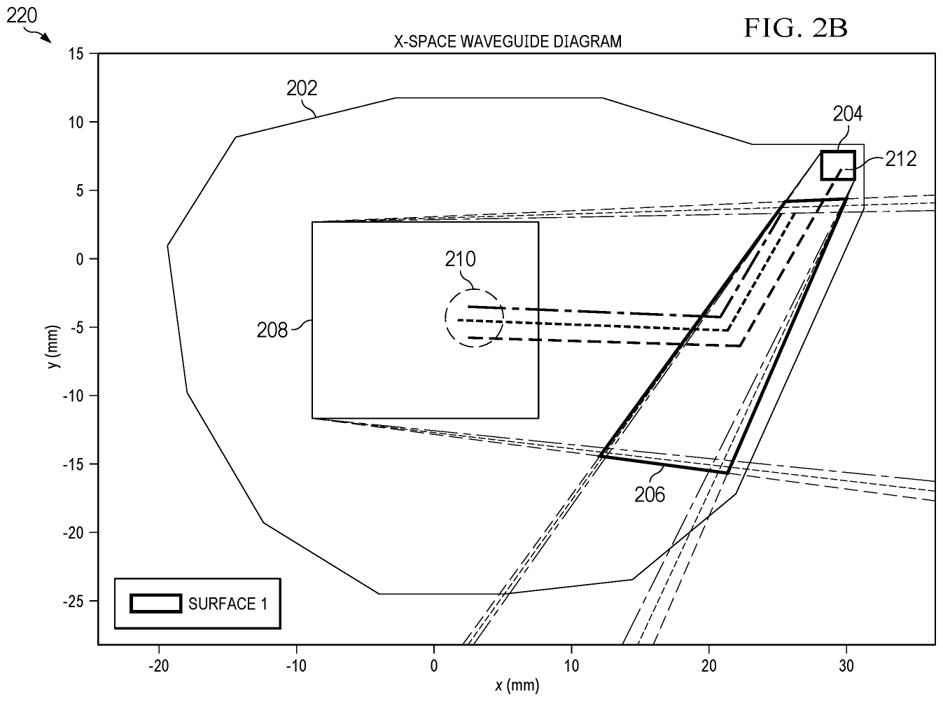

FIG. 2A is a diagram 200 illustrating total thickness variation (TTV) across components of a waveguide 202 and FIG. 2B is a corresponding x-space diagram 220 illustrating ray paths for different colors of display light to an exit pupil in accordance with some embodiments. The waveguide 202 includes an IC 204, an EPE 206, and an OC 208. The waveguide 202 is thickest in the upper right corner, where the IC 204 is located. The waveguide 202 becomes progressively thinner toward the lower left corner. The EPE 206 is located at the center right of the waveguide 202, and the OC 208 is located at the center left of the waveguide 202. Thus, the waveguide 202 is thinner at the OC 208 than at the EPE 206 and thinner at the EPE 206 than at the IC 204.

The x-space diagram 220 illustrates ray paths for a single color of display light through the waveguide 202. Display light is coupled into the waveguide 202 at a single point 212 in the IC 204. The display light is then guided through the EPE 206, which expands the pupil via a diffractive grating to an exit pupil 210 at the OC 208. The OC 208 couples the display light out of the waveguide 202.

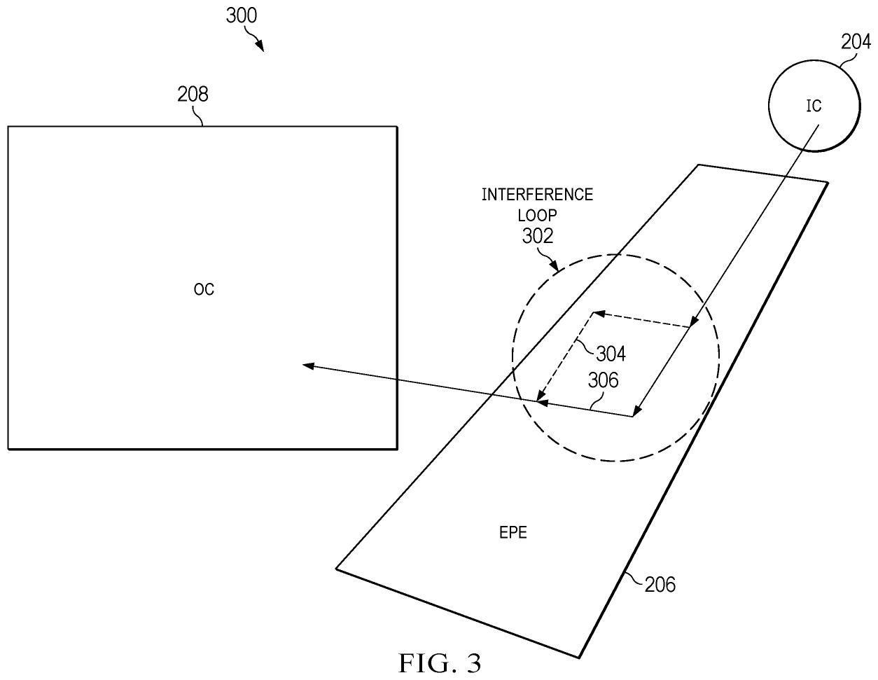

FIG. 3 is a diagram 300 illustrating paths of display light within components of a waveguide having surface deformations resulting in TTV across the components. Display light that is coupled into the waveguide from the IC 204 enters the EPE 206. The diffractive grating of the EPE 206 creates a network of interference loops such as interference loop 302. The interference loops split the display light into two portions or arms and then recombine the arms. As shown in the illustrated example, a first portion of the display light travels along a first path 304 and a second portion of the display light travels along a second path 306. At each node at which the paths 304, 306 intersect, the portions of display light intersect and experience constructive interference if the portions of display light have the same phase.

If light entering the waveguide from the display engine travels along two intersecting paths having identical lengths, the identical lengths of the intersecting paths cause light traveling along each path to accumulate the same amount of phase, resulting in constructive interference along a first direction at a first intersection and destructive interference along a second direction at the first intersection and reducing the overall efficiency of the EPE. Further, because the two paths have identical lengths, the interference occurs for all wavelengths of display light. Thus, in a conventional diffractive grating having a uniform grating structure and thickness across the area of the EPE 206, the same phase will accumulate for light traveling along path 304 and path 306, resulting in constructive interference for all wavelengths at the intersections of path 304 and path 306. Thus, for example at node 308, the display light will tend to go in a downward direction rather than sideways, toward the OC 208. The purpose of the EPE 206 is to redirect the light sideways into the OC 208, and the constructive interference causing the display light to deflect downward reduces the efficiency of the EPE 206.

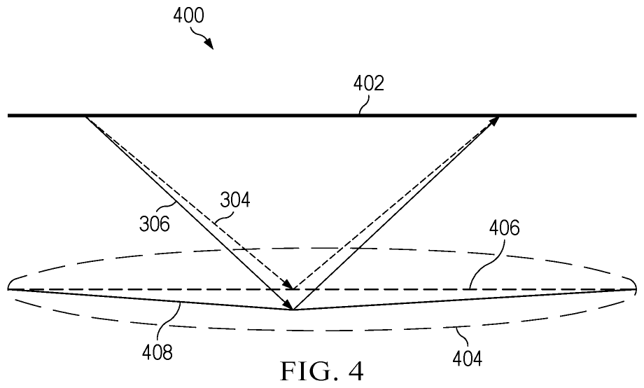

To improve the efficiency of the EPE 206, in some cases a phase difference is introduced between the two paths 304, 306. In other cases, the TTV across the waveguide introduces a phase difference between the two paths, as illustrated in FIG. 4. Whether the phase difference is intentionally introduced to improve efficiency or is caused by the TTV due to, e.g., the manufacturing process, the resulting change in the direction of light causes a lateral color misalignment that can degrade the image quality if it exceeds a threshold amount.

FIG. 4 is a diagram illustrating paths 304, 306 of display light within a side view 400 of a waveguide having surface deformations resulting in TTV across the components. The waveguide includes a first major surface 402 that is flat in the illustrated example and a second major surface 404 that includes surface deformities that cause the waveguide to have a variable thickness. Thus, a thickness 406 of the waveguide where display light traveling along the first path 304 reflects off the second major surface 404 differs from a thickness 408 of the waveguide where display light traveling along the second path 306 reflects off the second major surface 404.

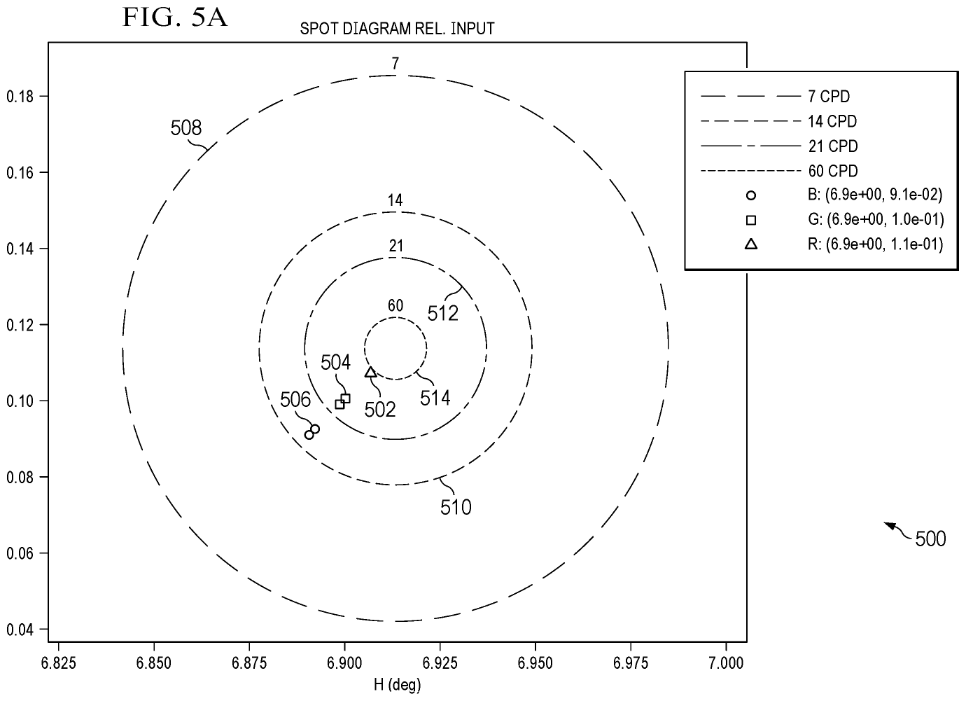

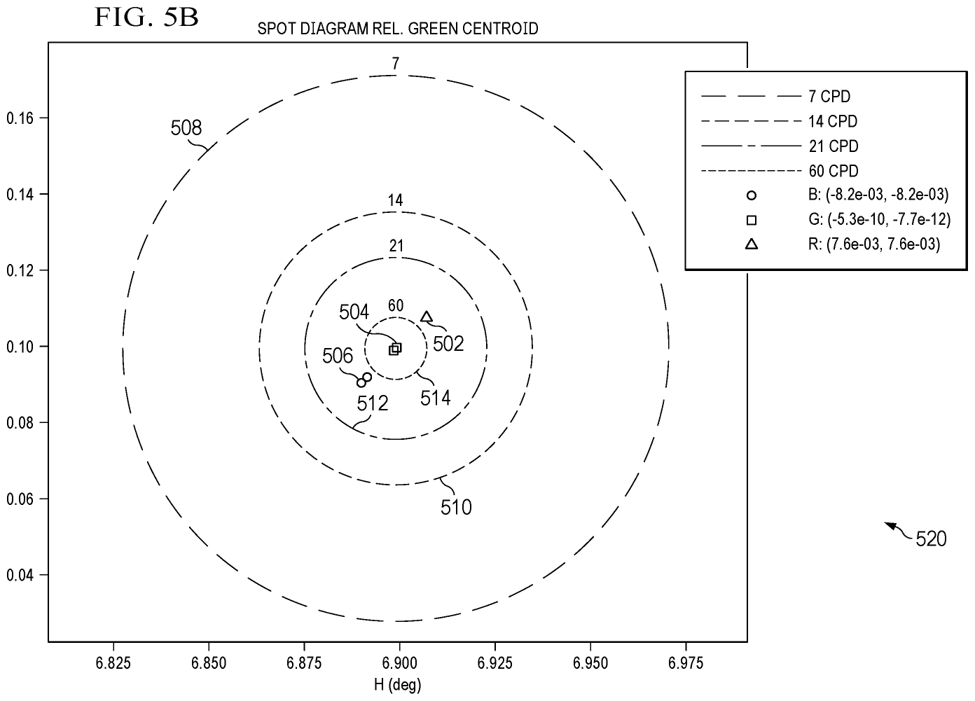

FIGS. 5A and 5B are a pair of spot diagrams 500, 520 illustrating lateral color misalignment due to surface deformations across components of a waveguide. Red light 502 traveling through a waveguide having surface deformations or TTV to an exit pupil is separated from green light 504 traveling through the waveguide to the exit pupil, and is yet further separated from blue light 506 traveling through the waveguide to the exit pupil. In an ideal waveguide having no surface deformations or TTV, the spots for each of red light 502, green light 504, and blue light 506 would overlap each other. However, the variable thickness of a waveguide manufactured using typical methods causes the different wavelengths of display light to travel paths having disparate lengths and to therefore experience different degrees of deflection by the diffractive gratings of the waveguide along a direction of the TTV (approximately 45° in the illustrated example). As a result of the varying degrees of deflection, the colors become separated.

Markers indicate an angular resolution (spatial frequency) of the spot diagram 500 as a measure of the number of cycles subtended at the eye per degree. For example, the ring 508 indicates 7 cycles per degree, the ring 510 indicates 14 cycles per degree, the ring 512 indicates 21 cycles per degree, and the ring 514 indicates 60 cycles per degree. For reference, a human with 20/20 vision can see 30 cycles per degree, and an image having a resolution of 60 cycles per degree would include fine details that would be imperceptible to some users. By contrast, an image having a resolution of less than 30 cycles per degree would appear blurry to many users.

The spot diagram 500 illustrates the lateral color misalignment centered relative to an ideal output angle of a waveguide having surface deformations such as TTV due to non-parallelism of the major surfaces of the waveguide. The spot diagram 520 illustrates the lateral color misalignment for the same input, with the illustrated output centered on the green color channel. Whereas the green light 504 remains within a small area well within 60 cycles per degree, the red light 502 is also within a small area but is separated from the green light 504. The blue light 506 has spread to a larger area and is separated from the green light 504 and even more separated from the red light 502 along a 45° angle corresponding to the cross-section of the waveguide along which the TTV is most pronounced. The overall distance between the blue light 506 and the red light 502 is within the range of human visual acuity, such that image quality degradation due to the lateral color misalignment is perceptible by the human eye.

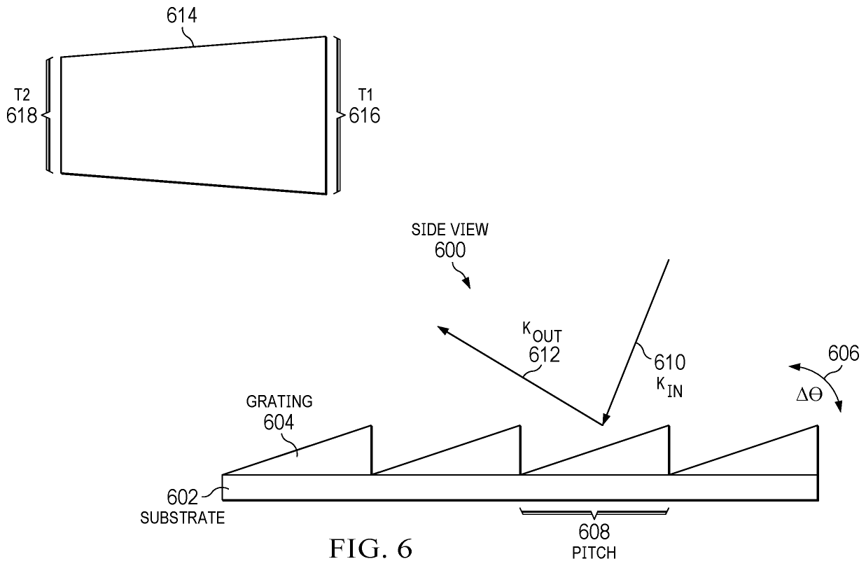

FIG. 6 illustrates a side view of a grating structure 600 having a phase perturbation to offset a lateral color misalignment due to surface deformations of a waveguide 614 (illustrated in cross-section to show the non-parallelism of the major surfaces) in accordance with some embodiments. The waveguide 614 is characterized by slightly non-parallel major surfaces (the non-parallelism of which is exaggerated in the illustrated example) such that a thickness T1 616 of the waveguide 614 at the thickest side is greater than a thickness T2 618 of the waveguide 614 at the thinnest side. In some examples, the difference between the thickness T1 616 and the thickness T2 618 is approximately 500 nanometers over a waveguide 614 width of approximately 50 millimeters along a 45° cross-section.

In some embodiments, the grating structure 400 is included in at least one of an EPE such as EPE 206 and an OC such as OC 208. The grating structure 600 includes a substrate 602 and a grating 604 having diffractive facets that diffract incident display light. The grating structure 600 is characterized by a pitch 608, which is the distance from the start of one facet to the start of the next facet. In the illustrated example, a beam of incident display light is represented by a vector kin 610, which hits the grating 604 and is scattered into a new direction with a vector kout 612. The scattering is characterized by an amplitude (which corresponds to the efficiency of the scattering) and a phase. If the light beam reflects at the same angle as the angle of incidence (e.g., if kin 610=kout 612 in a lateral dimension), then the phase value does not depend on an angular displacement (rotation) Δθ 606 of the grating.

However, if the beam of incident display light is deflected by (i.e., has its direction changed by) the grating 604, then kin 610≠kout 612, and an additional phase value can be introduced. To mitigate the dispersive effects on different wavelengths of display light by the surface deformations of the waveguide 614, in some embodiments, the pitch 608 of the diffractive grating 604 is tuned to change the k-vector of the grating in the direction of change in total thickness variation (TTV) across the waveguide 614. In some embodiments, the grating structure 600 is rotated by an amount Δθ 606 to change the k-vector of the grating in the direction of change in TTV across the waveguide 614. The dispersive nature of the diffractive grating 604 causes the small change in the k-vector of the grating in the direction of the TTV to have a greater effect on red light than on blue light. Thus, by adding a phase perturbation to the grating structure 600, the lateral color alignment of light guided through the waveguide is mitigated or even canceled in some embodiments.

Because rays of display light are deflected more by the TTV or other surface deformities of the waveguide the further they travel through the waveguide, in some embodiments, the amount of phase perturbation added to the grating 604 changes varies spatially across the grating 604 to reduce the accumulated color dispersion at each position of the grating 604. For example, in some embodiments, regions of the grating 604 that are closer to the IC 204 have a smaller phase perturbation and regions of the grating that are farther from the IC 204 have a larger phase perturbation. The transitions from one region of the grating to the next are implemented as gradual shifts in the pitch 608 and/or rotation Δθ 606 in some embodiments to reduce an edge effects from abrupt changes in grating characteristics across the grating 604.

To compensate for the variable image deformation based on pupil position within the eyebox of the waveguide 614, in some embodiments, the AR eyewear display system 100 includes an eye tracker and a controller. The eye tracker (not shown) tracks a gaze location of a user of the AR eyewear display system 100 and communicates the gaze location to the controller (not shown). The controller applies an image distortion compensation effect in the image pipeline between the processor and the micro-display to pre-compensate the projected display light such that the displayed image is modified based on a detected gaze location to offset the variable image deformation in some embodiments.

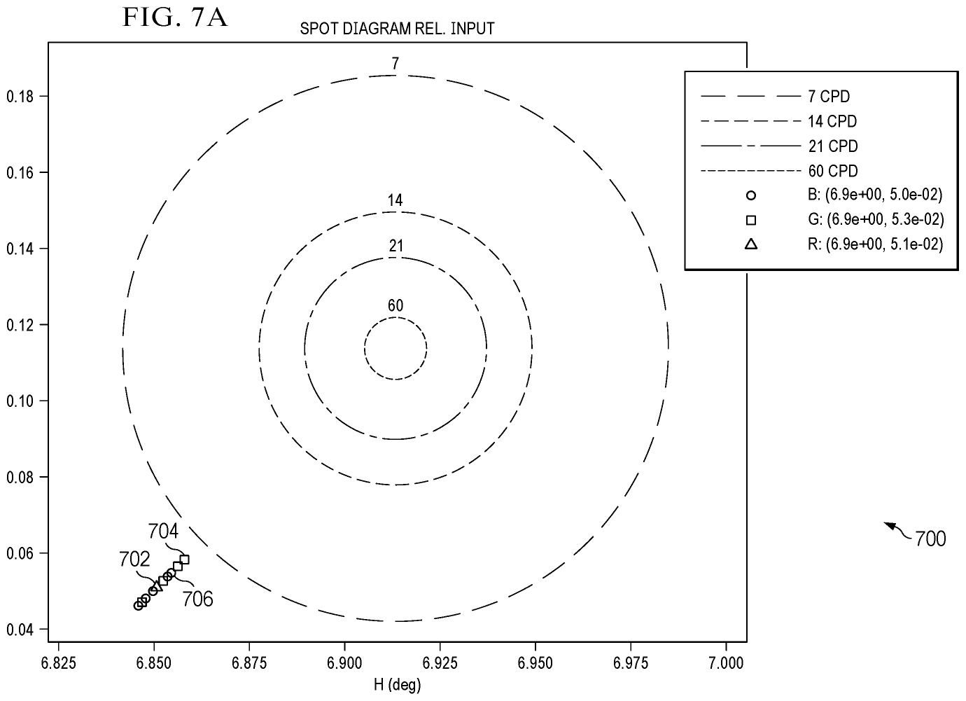

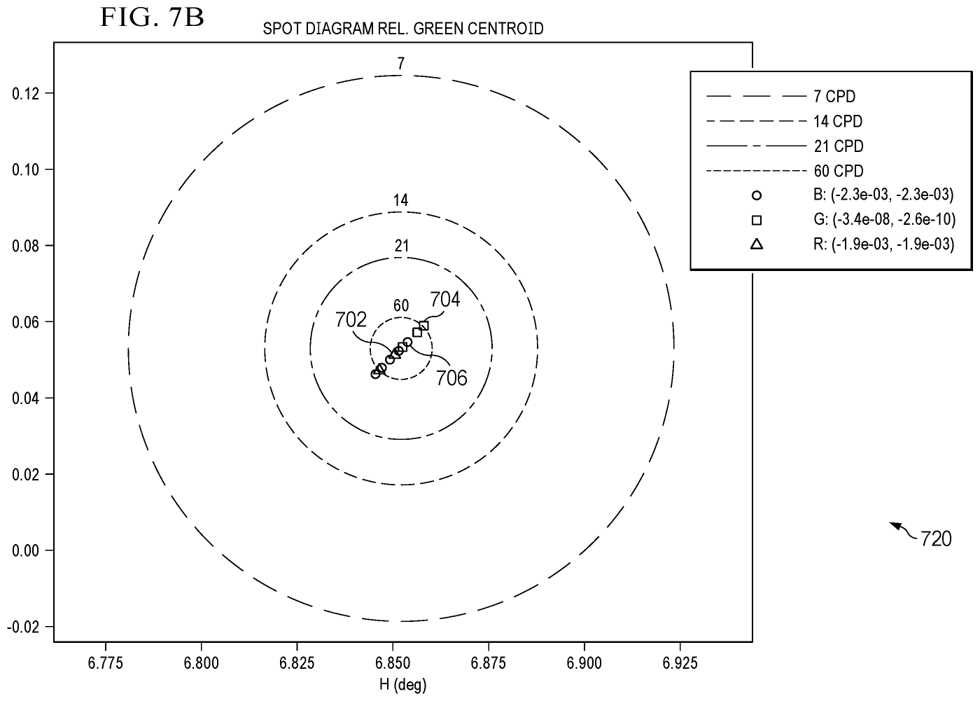

FIGS. 7A and 7B are a pair of spot diagrams 700, 720 illustrating correction of lateral color misalignment due to surface deformations of a waveguide by a phase perturbation of a grating structure in accordance with some embodiments. By introducing a k-vector perturbation along to the grating along a direction of the greatest TTV of the waveguide 614 (e.g., along a 45° angle in the illustrated example), the grating reduces lateral color misalignment such that all points (e.g., for red, green, and blue light) are directed to an area within 60 cycles per degree and the colors are more closely aligned than in a waveguide having surface deformations without a grating having a compensatory phase perturbation, as illustrated in FIGS. 5A and 5B.

The spot diagram 700 illustrates the lateral color alignment due to the phase perturbation(s) of the grating 604 centered relative to an ideal output angle of a waveguide having surface deformations such as TTV due to non-parallelism of the major surfaces of the waveguide. The spot diagram 720 illustrates the lateral color alignment for the same input, with the illustrated output centered on the green color channel. Due to the dispersive effect of the diffractive grating 604, the change in the k-vector of the grating in the direction of the TTV across the waveguide 614 has a greater effect on red light 702 than on blue light 706 (and an intermediate effect on green light 704). The combined effect of the TTV (which affects blue light more than red light) and the phase perturbation of the diffractive grating 604 (which affects red light more than blue light) is to more closely align centroids of all three color channels to within 60 cycles per degree.

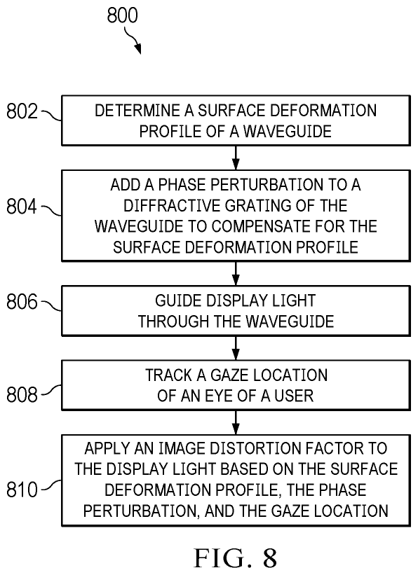

FIG. 8 is a flow diagram illustrating a method 800 of adding a phase perturbation to a grating structure to offset lateral color misalignment due to surface deformations of a waveguide in accordance with some embodiments. In some embodiments, the method 800 is practiced at an AR eyewear display system such as AR eyewear display system 100 employing a waveguide having a surface deformation profile similar to that of waveguide 614 and a grating structure such as grating structure 600.

At block 802, a surface deformation profile of the waveguide 614 is determined. For example, in some embodiments, a TTV resulting from a difference between a thickness T1 616 at a thickest point along a cross-section of the waveguide and a thickness T2 614 at a thinnest point along the cross-section is measured or otherwise determined. The surface deformation profile deflects light of different wavelengths by varying degrees, resulting in lateral color misalignment as display light is guided through the waveguide. At block 804, a phase perturbation is added to a diffractive grating such as at least one of an EPE and an OC of the waveguide to offset a lateral color misalignment due to the surface deformation profile of the waveguide 614.

At block 806, display light is guided through the waveguide 614. For example, in some embodiments, a micro-display or other light engine projects display light toward an IC 204 of the waveguide to couple the display light into the waveguide 614, where the display light is guided by total internal reflection as the display light bounces off the major surfaces of the waveguide 614. Whereas the TTV of the waveguide 614 separates the different colors of display light due to the non-parallelism of the major surfaces of the waveguide, the phase perturbation of the diffractive grating 600 realigns the colors by changing the k-vector of the diffractive grating in a direction of the TTV. In some embodiments, the phase perturbation is implemented by modifying at least one of the pitch 608 and rotation 606 of the diffractive grating 614. In some embodiments, the amplitude of the phase perturbation varies across the diffractive grating 600.

Although the phase perturbation deflects all rays across the field of view (FOV) of the AR eyewear display system 100 by a substantially equal k-space vector, it does not deflect all the rays by an equal angle. Accordingly, some deformation may be introduced into the image displayed to the user. In some cases, the deformation changes based on the location of the user's pupil within the eyebox of the waveguide 614. In some embodiments, the AR eyewear display system 100 includes an eye tracker. In such embodiments, at block 808, the eye tracker tracks a gaze location of a user of the AR eyewear display system 100 and communicates the gaze location to a controller. At block 810, the controller applies an image distortion factor to the display light based on the surface deformation profile of the waveguide 614, the phase perturbation, and the gaze location to pre-compensate for the gaze-dependent image distortion.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
guiding display light through a waveguide having surface deformations that laterally separate colors of the display light; and
adding a phase perturbation to a diffractive grating of the waveguide to offset the lateral separation of the colors.

2. The method of claim 1, wherein adding the phase perturbation comprises modifying at least one of a pitch and rotation of the diffractive grating.

3. The method of claim 1, wherein the waveguide comprises non-parallel major surfaces.

4. The method of claim 3, wherein adding the phase perturbation comprises modifying a k-vector of the diffractive grating by an amount corresponding to a total thickness variation across the waveguide due to the non-parallel major surfaces.

5. The method of claim 1, wherein the diffractive grating comprises at least one of an exit pupil expander and an outcoupler.

6. The method of claim 1, further comprising:
spatially varying the phase perturbation along a lateral position of the diffractive grating.

7. The method of claim 1, further comprising:
guiding the display light through the diffractive grating to an eyebox of the waveguide with a spatial frequency of at least 20 cycles per degree for centroids of all colors of the display light.

8. The method of claim 7, further comprising:
tracking a gaze location within the eyebox of an eye of a user of an eyewear display device comprising the waveguide; and
applying an image distortion factor to the display light based on the surface deformations and the gaze location.

9. A device, comprising:
a waveguide configured to guide display light, the waveguide comprising:
a first major surface and a second major surface having deformations that laterally separate colors of the display light; and
a diffractive grating comprising a phase perturbation configured to offset the lateral separation of the colors.

10. The device of claim 9, wherein the phase perturbation comprises a modification to at least one of a pitch and rotation of the diffractive grating.

11. The device of claim 9, wherein the first major surface and the second major surface are non-parallel.

12. The device of claim 11, wherein the phase perturbation is configured to modify a k-vector of the diffractive grating by an amount corresponding to a total thickness variation across the waveguide due to the non-parallel major surfaces.

13. The device of claim 9, wherein the diffractive grating comprises at least one of an exit pupil expander and an outcoupler.

14. The device of claim 9, wherein the phase perturbation varies spatially along a lateral position of the diffractive grating.

15. The device of claim 9, wherein the phase perturbation is configured to guide the display light through the diffractive grating to an eyebox of the waveguide with a spatial frequency of at least 20 cycles per degree for centroids of red, blue, and green display light.

16. The device of claim 15, further comprising:
an eye tracker configured to track a gaze location within the eyebox of an eye of a user of an eyewear display device comprising the waveguide; and
a controller configured to apply an image distortion factor to the display light based on the surface deformations and the gaze location.

17. An eyewear display device, comprising:
a waveguide configured to guide display light to an eyebox, comprising:
non-parallel major surfaces that laterally separate colors of the display light; and
a diffractive grating comprising a phase perturbation configured to modify a k-vector of the diffractive grating by an amount corresponding to a total thickness variation across the waveguide due to the non-parallel major surfaces.

18. The eyewear display device of claim 17, wherein the phase perturbation comprises a modification to at least one of a pitch and rotation of the diffractive grating.

19. The eyewear display device of claim 17, wherein the phase perturbation varies spatially along a lateral position of the diffractive grating.

20. The eyewear display device of claim 17, further comprising:
an eye tracker configured to track a gaze location within the eyebox of an eye of a user of an eyewear display device comprising the waveguide; and
a controller configured to apply an image distortion factor to the display light based on the total thickness variation and the gaze location.
